(19) United States
(12) Patent Application Publication
(10) Pub. No.: US 2003/0013010 A1
(43) Pub. Date: Jan. 16, 2003

(54) Positive pole structure for batteries

(75) Inventor: Chin-Tong Liu, Hsinchu (TW)

Correspondence Address: SUPREME PATENT SERVICES, POST OFFICE BOX 2339, SARATOGA, CA, 95070, US

(73) Assignee: Iuan-Jou Yang

(21) Appl. No.: 09/902,879

(22) Filed: Jul. 11, 2001

(51) Int. Cl. H01M 2/18; H01M 2/26; H01M 2/08

(52) U.S. Cl. 429/130; 429/161; 429/211; 429/174

(57) ABSTRACT

A battery includes a container with electrolyte filled therein and a plurality of positive plates, a plurality of separation layers and a plurality of negative plates are alternatively arranged in the container. The negative plates are connected to an inside of a negative end of the container and the positive plates are connected to a nickel member which is connected to an upper plate in a positive end of the container. An alkali proof rubber is located between the nickel member and the upper plate. A positive cap is connected to the upper plate and extends from a positive end of the container.

### FIELD OF THE INVENTION

The present invention relates to a positive pole structure for a battery and includes an alkali proof rubber clamped between the upper plate and a nickel plate to which positive pole plates are connected.

### BACKGROUND OF THE INVENTION

A conventional positive pole structure for a battery is shown in FIG. 1 and generally includes a cylindrical metal container 10 in which electrolyte is filled, and a plurality of positive plates 11, separation layers 12 and negative plates 13 alternatively wrapped about an axis of the container 10. The positive plates 13 are respectively welded to a nickel plate 18 at points 111 and the negative plates 13 are respectively connected to the inside of the container 10. An upper plate 14 is welded to a positive cap 15 and a rubber 17 is located between the upper plate 14 and the positive cap 15. Two sides 181 of the nickel plate 18 are bent and welded to an underside of the upper plate 14. A separation member 19 is connected to the outside of the container 10 to prevent short between the positive pole and the negative pole. Some inherent shortcomings of the conventional batteries are there are too many welding points which will affect and reduce the efficiency of discharge of the batteries. The welding points require many skilled labors and the equipment for completion of the batteries is costly.

### SUMMARY OF THE INVENTION

In accordance with one aspect of the present invention, there is provided a battery which comprises a metal container having electrolyte filled therein and a plurality of positive plates, a plurality of separation layers and a plurality of negative plates are alternatively arranged in the container. The negative plates are connected to an inside of a negative end of the container. A nickel member is connected to an upper plate in a positive end of the container. An alkali proof rubber is located between the nickel member and the upper plate. The positive plates are connected to the nickel member. A positive cap is connected to the upper plate and extends from a positive end of the container. A rubber is located between the positive cap and the upper plate.

The primary object of the present invention is to provide a positive pole structure of a battery wherein the upper plate and the nickel plate are combined by an alkali proof rubber located between the upper plate and the nickel plate.

The present invention will become more obvious from the following description when taken in connection with the accompanying drawings which show, for purposes of illustration only, a preferred embodiment in accordance with the present invention.

### BRIEF DESCRIPTION OF THE DRAWINGS

FIG. 1 is a cross sectional view to show a conventional battery;

FIG. 2 is a cross sectional view to show a battery of the present invention;

FIG. 3A is an exploded view to show a first embodiment of the nickel plate and the alkali proof rubber in the battery of the present invention;

FIG. 3B is an exploded view to show a second embodiment of the nickel plate and the alkali proof rubber in the battery of the present invention;

FIG. 3C is a perspective view to show the combination of the nickel plate and the alkali proof rubber as shown in FIG. 3B;

FIG. 4 shows a chart illustrating 20 batteries of the present invention connected in series and discharge in four different amperes of currents, and

FIG. 5 shows a chart illustrating the 20 batteries of the present invention connected in series and are charged at minus 10 degrees Celsius and are discharged at minus 5 degrees Celsius.

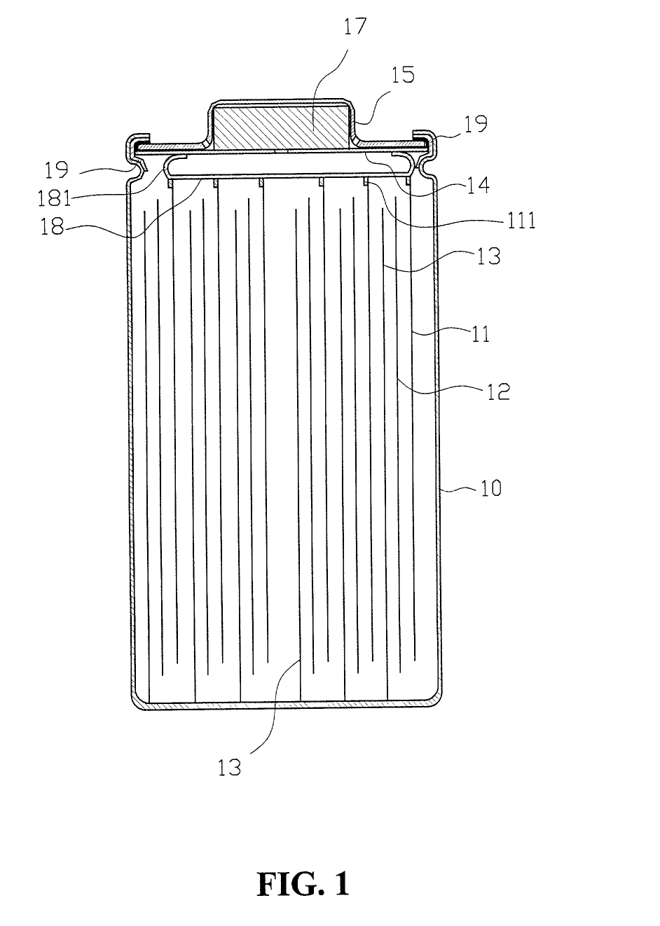

### DETAILED DESCRIPTION OF THE INVENTION

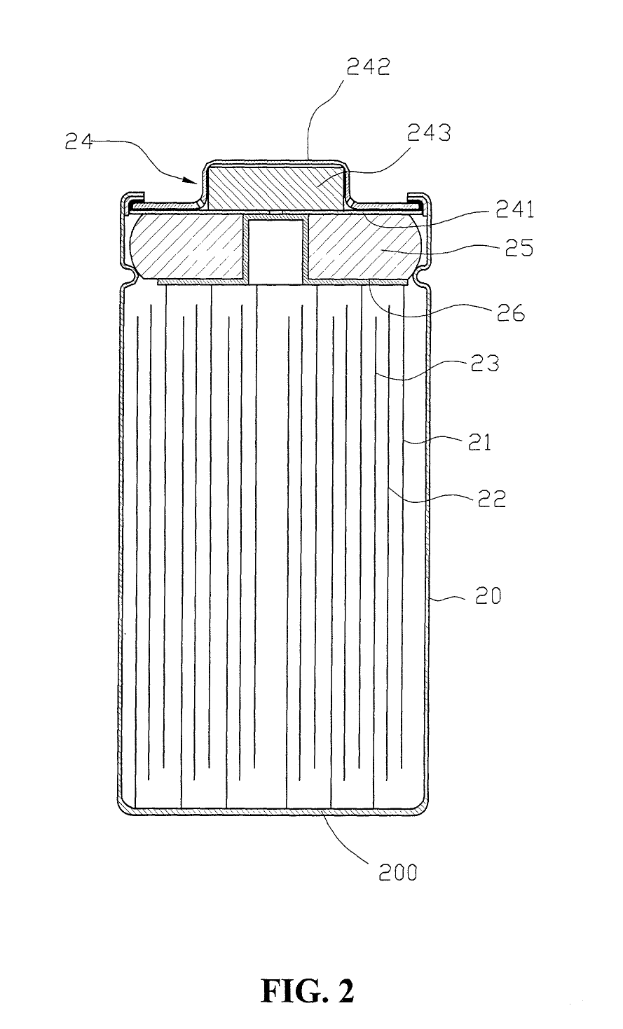

Referring to FIG. 2, the battery of the present invention comprises a metal container 20 having electrolyte filled therein and a plurality of positive plates 21, a plurality of separation layers 22 and a plurality of negative plates 23 are alternatively arranged in the container 20. The positive plates 21, the separation layers 22 and the negative plates 23 are rolled about an axis of the container 20. The negative plates 23 have an end connected to an inside of a negative end 200 of the container 20, and the other end of each negative plate 23 is a free end.

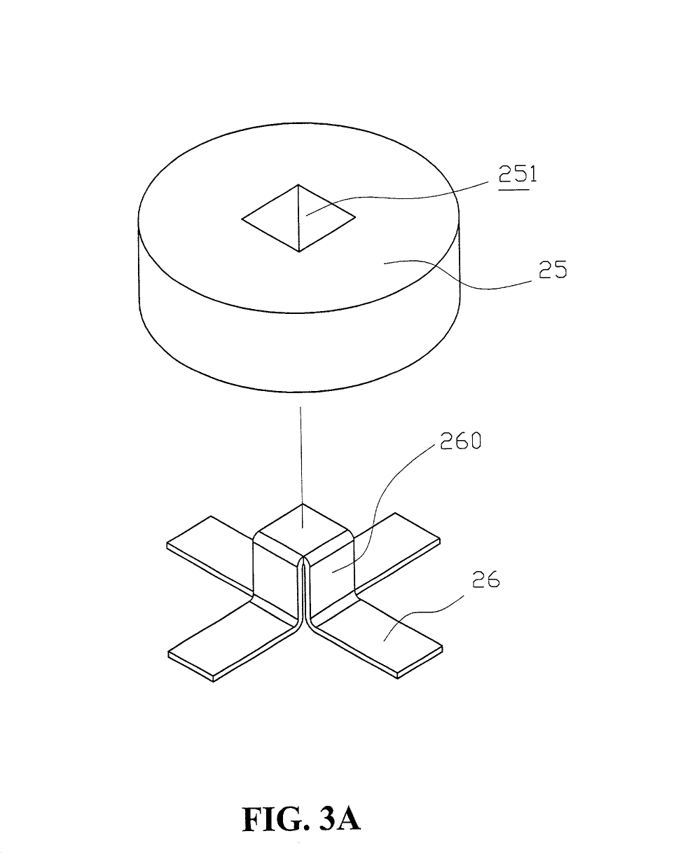

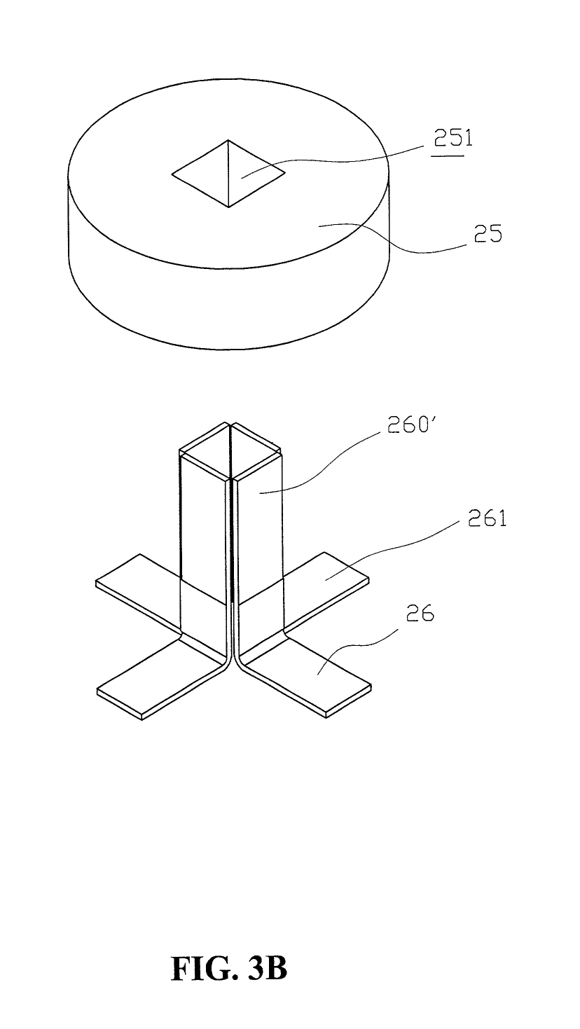

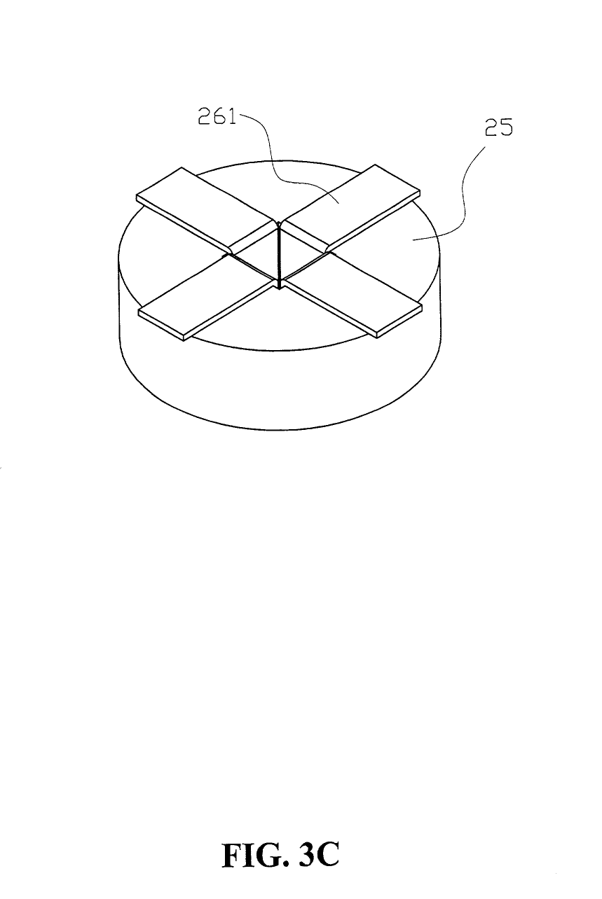

A nickel member 26 is connected to an upper plate 241 and both are located in a positive end 24 of the container 20. As shown in FIG. 3A, the nickel member 26 has a protrusion 260 and the alkali proof rubber 25 has a passage 251 through which the protrusion 260 extends. The top surface of the protrusion 260 contacts an underside of the upper plate 241. The alkali proof rubber 25 is secured located between the nickel member 26 and the upper plate 241, by this way, the upper plate 241 is not necessary to be welded to the nickel member 26. A positive cap 242 is connected to the upper plate 241 and extends from the positive end 24 of the container 20. A rubber 243 is located between the positive cap 242 and the upper plate 241.

FIGS. 3B and 3C shows another embodiment of the combination of the nickel member 26 and the alkali proof rubber 25. The nickel member 26 may have a longer protrusion 260′ which extends through the passage 251 of the alkali proof rubber 25, and a plurality of extension plates 261 extending from the longer protrusion 260′ so as to contact a surface of the alkali proof rubber 25. The extension plates 261 contact the underside of the upper plate 241.

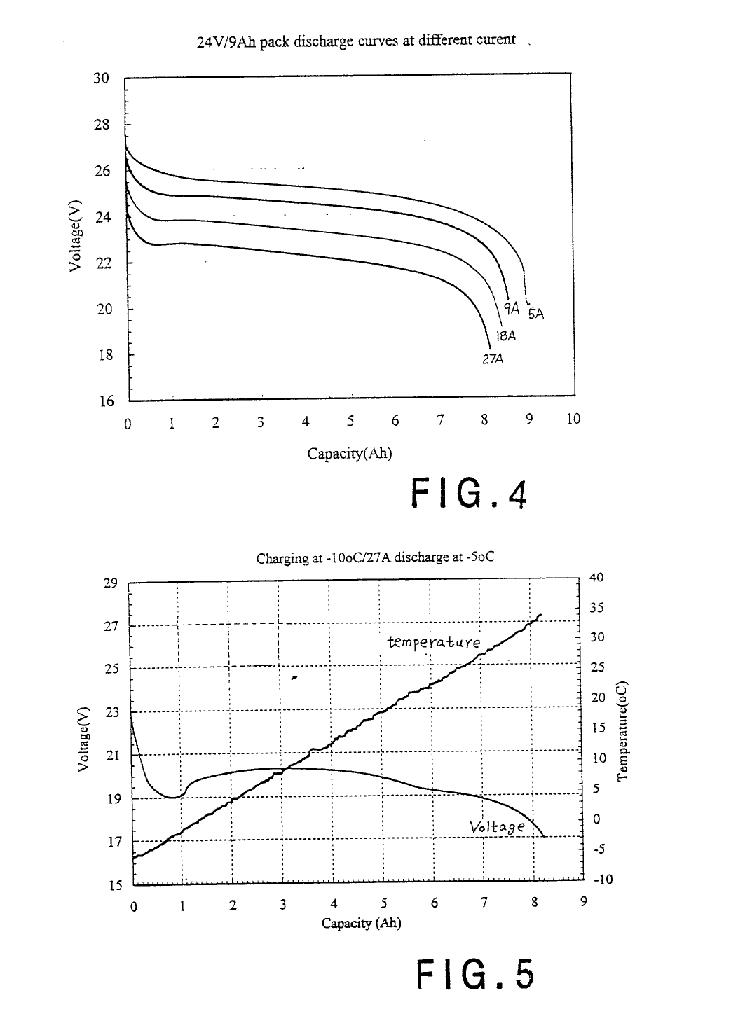

FIG. 4 shows that 20 batteries of the present invention are connected in series and discharge in four different amperes of currents. It shows that all the 20 batteries have stable characters and are durable under 27-ampere discharge.

FIG. 5 shows the 20 batteries of the present invention connected in series and are charged at minus 10 degrees Celsius and are discharged at minus 5 degrees Celsius. It shows that the batteries of the present invention are less affected by the change of temperature.

While we have shown and described the embodiment in accordance with the present invention, it should be clear to those skilled in the art that further embodiments may be made without departing from the scope of the present invention.

What is claimed is:

1. A battery comprising:
a container having electrolyte filled therein and a plurality of positive plates, a plurality of separation layers and a plurality of negative plates alternatively arranged in said container, said negative plates connected to an inside of a negative end of said container;
a nickel member connected to an upper plate and both located in a positive end of said container, an alkali proof rubber located between said nickel member and said upper plate, said positive plates connected to said nickel member, and
a positive cap conned to said upper plate and extending from a positive end of said container, a rubber located between said positive cap and said upper plate.

2. The battery as claimed in claim 1, wherein said nickel member has a protrusion and said alkali proof rubber has a passage through which said protrusion extends.

3. The battery as claimed in claim 1, wherein said nickel member has a plurality of extension plates which contact a surface of said alkali proof rubber.
